(19) United States
(12) Patent Application Publication
(10) Pub. No.: US 2023/0153479 A1
(43) Pub. Date: May 18, 2023

(54) REAL TIME AUGMENTED REALITY SELECTION OF USER FITTED EYEGLASS FRAMES FOR ADDITIVE MANUFACTURE

(71) Applicant: Ocularex, Inc., Roanoke, VA (US)

(72) Inventors: MICHAEL S. BRADLEY, SR., Johnson City, TN (US); MICHAEL S. BRADLEY, JR., Roanoke, VA (US); PATRICK D. BRADLEY, Roanoke, VA (US)

(21) Appl. No.: 17/916,579

(22) PCT Filed: Apr. 2, 2021
(86) PCT No.: PCT/US2021/025679

§ 371 Date: Oct. 2, 2022

Related U.S. Application Data
(60) Provisional application No. 63/004,151, filed on Apr. 2, 2020.
(60) Provisional application No. 63/061,170, filed on Aug. 4, 2020.
(60) Provisional application No. 63/150,561, filed on Feb. 17, 2021.

(51) Int. Cl. G06F 30/12; G02C 13/00; B29C 64/393; B33Y 50/02

(52) U.S. Cl. CPC G06F 30/12; G02C 13/003; B29C 64/393; B33Y 50/02; G06F 2111/18

(57) ABSTRACT

Systems and methods for the real time augmented reality selection of user fitted eyeglass frames for additive manufacture are provided. 3D design files for additive manufacturing and corresponding 3D visual renderings for an augmented reality display of fitted eyeglass frames are provided using a digital inventory. Users may try-on the fitted eyeglass frames in real time using augmented reality and efficiently manufacture the eyeglass frames using 3D printing.

### CROSS-REFERENCE TO RELATED APPLICATIONS

This application is a U.S. National Stage of International Application No. PCT/US21/25679 filed Apr. 2, 2021 which claims the benefit of U.S. Provisional Patent Application Ser. Nos. 63/004151 filed Apr. 2, 2020, App. No. 63/061170 filed Aug. 4, 2020, and App. No. 63/150561 filed Feb. 17, 2021, all of which are hereby incorporated by reference in their entirety.

### BACKGROUND

Although certain types of additive manufacturing technology, such as 3D printing, for wearable eyeglass frames is capable, eyeglass frames are overwhelmingly manufactured using progressive die manufacturing processes. The lack of mass adoption of additive manufacturing for eyeglass frames may be partly due to the high-volume production limitations, particularly high-volume production requirements, of additive manufacturing as compared to more conventional eyeglass manufacturing methods as well as the time and complexities required to 3D model an eyeglass frame design.

Eyeglass frames are selected based on a highly individualized combination of fit and design preference, and consumers expect to be able to try-on fitted eyeglass frames before purchase. The traditional and favored on-site optician or optical store eyeglass frame fit and selection process entails a consumer examining and trying-on a selection of fitted design frames in-store, often with the guidance of an optician or optical store representative trained in both eyeglass frame fit and design preferences. However, this process, while the most effective in achieving a well-fitted eyeglass frame in a design selected by the consumer, can be time consuming and limited to costly on-site eyeglass inventory. And off-site computerized solutions often require mail-in and mail-back eyeglass frame processes, or lack effective frame selection guidance and processes for a successful well-fit frame and consumer happy end result as it remains difficult to provide a consumer with an eyeglass frame that meets both an individual's eyeglass fit and design requirements.

And yet even with the improvement of facial measurement technology and augmented reality technology, often combined in application program interface frameworks for camera integrated computing devices such as smartphones, laptops, tablets, and desktop computers, challenges persist in effective and efficient real time eyeglass frame fit and design selection, including the ability for a consumer to try-on fitted eyeglasses ready for additive manufacture, such as 3D printing, using augmented reality, as well as selection fatigue which may result in less preferred sub-optimal design selection decisions.

### DESCRIPTION

The following description is not to be taken in a limiting sense, but is made for the purpose of describing the general principles of the present disclosure. The scope of the present disclosure should be determined with reference to the claims. Exemplary embodiments of the present disclosure may be illustrated in the drawings, like numbers being used to refer to like and corresponding parts of the various drawings. The dimensions of drawings provided are not shown to scale.

The scope of the invention may be advantageously directed towards the efficient and effective additive manufacture of fitted and design selected eyeglass frames.

And although described with reference to eyeglass frames, the solutions provided herein may be equally applicable to sunglass frames.

The terms “user” and “consumer” are intended to refer to the individual selecting the fitted eyeglass frames.

The terms “pre-designed” and “pre-defined” used with reference to eyeglass frames are intended to describe an eyeglass frame in a digital inventory.

The term “fitted eyeglass frame” is intended to refer to eyeglass frames that have been fitted to the face of a consumer.

The term “real time” is intended to refer to time increments in the milliseconds range.

The term “side-by-side” is intended to refer, in the context of eyeglass frames, to more than one display window on a screen of a 3D visual rendering of an eyeglass design on a user's face using augmented reality, each display having a 3D visual rendering of a different eyeglass design.

The present application provides a comprehensive solution for the additive manufacture of consumer fitted and consumer design selected eyeglass frames. Innovative aspects of the disclosed solutions include, but are not limited to, the additive manufacturing of consumer fitted and consumer selected eyeglass frames and an innovative eyeglass design selection process with augmented reality eyeglass frame try-on allowing the consumer to try-on fitted eyeglass frames from a digital inventory of eyeglass frames for additive manufacture. These innovative aspects allow for reductions in on-site eyeglass frame inventory, reductions in eyeglass frame manufacturing costs, and improvement of accuracy and efficiency in eyeglass fit and eyeglass design selection.

### Digital Inventory for 3D Printing and Augmented Reality

An innovation and improvement of the disclosed solution is a digital inventory of pre-designed eyeglass frames. The digital inventory of pre-designed eyeglass frames has 3D designs for additive manufacturing of eyeglass frames such as 3D design files for additive manufacturing (e.g., in CAD STL or 0.3 dm file format from Rhino CAD system or equivalent and stored in centralized or remote data centers using a cloud storage model). Corresponding eyeglass frame 3D visual renderings in a graphics format (e.g., WebGL file format or equivalent) may be stored in the digital inventory or these 3D visual renderings may be generated by a 3D visual renderings generator. By providing both a 3D design file for additive manufacturing and a corresponding 3D visual rendering for an augmented reality display of an eyeglass frame, the fitted eyeglass frame may be both tried on in real time using augmented reality and efficiently and timely manufactured using 3D printing.

Display and real time consumer try-on of fitted eyeglass frames using augmented reality substantially heightens both confidence in eyeglass design selection as well as efficiency in the selection process. By providing real time augmented reality display of fitted eyeglass frames based on 3D visual renderings of 3D design files for additive manufacturing, opticians and optical shops are able increase the number of fitted eyeglass frames available for a user to try-on, via augmented reality, as well as reduce on-site physical eyeglass frame inventory.

The pre-designed eyeglass frames may be advantageously based on global eyewear industry standard frame measurements in integer millimeter increments for the dimensions of the eyeglass face plate, temple pieces, inter pupillary distance (IPD) for correct lens placement, and segment height (SH) for bifocals, trifocals and continuous focals. Providing yet additional improvement, at the integer millimeter unit of measurement granularity, both fit accuracy is improved as, for example, facial measurement data is effectively and efficiently captured at the millimeter scale, and manufacturing is improved as, for example, a 3D printer processes a 3D design file for manufacturing effectively and efficiently at the millimeter scale.

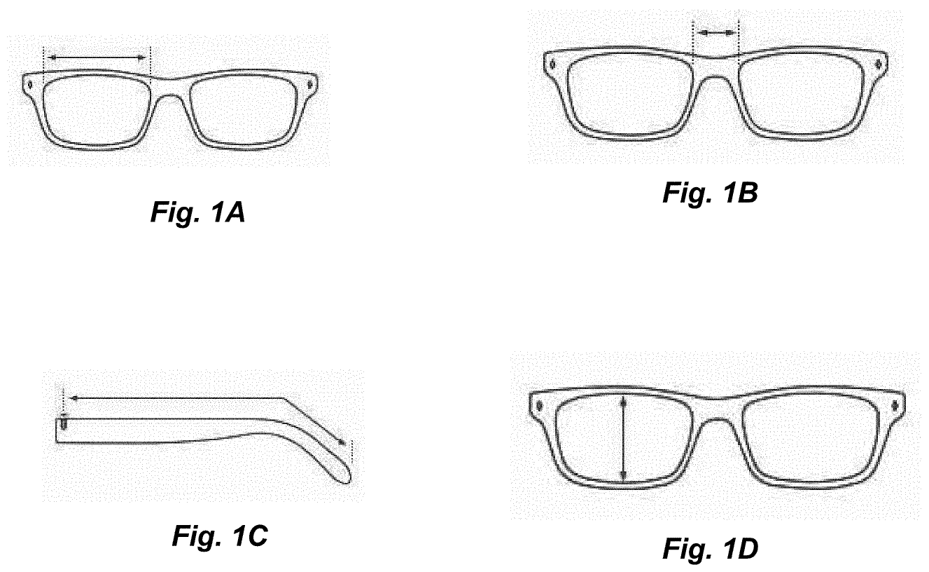

FIGS. 1A through 1D are eyeglass diagrams showing lens width, bridge width, temple (arm) length, and lens height, respectively. Lens width, shown in FIG. 1A, is the horizontal width of each lens at its widest point and typically ranges from 40 mm to 60 mm. Bridge width, shown in FIG. 1B, is the distance between the two lenses. In short, the bridge width spans the space where eyeglass frames fit against a nose. Bridge width typically ranges from 14 mm to 24 mm. Temple (arm) length, shown in FIG. 1C, is the length of the temple from each screw to its temple tip, including the bend that sits on an ear. The temple length is typically 120 mm to 150 mm. Lens height, shown in FIG. 1D, is the vertical height of the eyeglass lenses at the widest point of the lens within the frame. The lens height is particularly important when measuring bifocals or progressive lenses.

### Side-by-Side 3D Visual Renderings of Eyeglass Designs on a User's Face in Augmented Reality

Yet another innovation and improvement of the disclosed solution is an interactive augmented reality based fitted eyeglass frame design selection such that the user is displayed wearing two different fitted eyeglass frames in side-by-side augmented reality. In other words, the 3D visual renderings for the side by side comparisons of the selected eyeglass frames from the digital database (e.g., cloud server digital database with online access) are mapped onto the consumer's face. Thus, a real time side-by-side display of the selected eyeglass frames on the consumers face as if they are looking into a mirror is provided. The rendering of the two eyeglass frames is adjusted as the consumer turns their head side-to-side or moves their chin up or down. Parts of the frames, particularly the frame arms, may be occluded by the consumer's hair if it is covering part of the frames.

### Capturing Emotional Response Cues to Eyeglass Frame Designs

Yet another innovation and improvement of the disclosed solution is the capture of emotive responses during eyeglass frame selection. Emotive responses are captured by measuring time-series responses to changes in the retail customer's individual and composite(s) facial features. Capturing emotional response cues to eyeglass frame designs and determining eyeglass frame display selection and display methods are used to substantially improve the efficiency and effectiveness of the fitted eyeglass frame selection process. Selecting a fitted eyeglass frame may be an emotional decision based on aesthetic choices, by capturing and applying non-verbal emotional response cues the selection process may be improved. Thus, the user is provided with an improved and optimized selection and selection presentation of 3D visual renderings of pre-designed fitted eyeglass frames based on captured facial measurement data of the user as well as captured emotional response cues.

As an innovation, the side-by-side augmented reality comparison of fitted eyeglass designs provides numerous improvements including design selection process efficiency and frame selection confidence. Importantly, when combined with the innovations of emotional response cue capture based on facial expressions and facial expression changes as described below, the side-by-side augmented reality comparison of fitted eyeglass designs improves the measurement of facial expression and facial expression changes by providing target images. Measurement and capture of facial expressions is particularly challenging during the selection of eyeglass frames, and the selection of other facial or head products such as dental inserts or ear inserts, as the user will move their heads, and thus face, to view product fit and aesthetics to make their selection. A side-by-side comparison provides displayed target images for improved and more accurately measured and captured facial expressions and facial expression changes as the user moves their eyes between display frame one fitted eyeglass frame design one on the user's face and display frame two having fitted eyeglass frame design two on the user's face.

Fitted eyeglass frame design selection is further innovated and improved upon and optimized by reducing eyeglass selection fatigue through the capture and application of emotional response cues based on measurement of facial expressions and facial expression changes during the fitted eyeglass design selection process. A user's emotion response cues may be captured during the presentation and display of a selection fitted eyeglass frame designs. As the selection of fitted eyeglass frames is narrowed, a user's emotional response cues are applied to rank the narrowing display selection of consumer selected fitted eyeglass frames. Emotional response cue data to selected frame designs as well as presented but unselected frame designs may be used to further improve and optimize the fitted eyeglass frame selection process for later users.

### Personalization of Surface Colors

A selection of 3D visual renderings of pre-designed fitted eyeglass frames are selected, including eyeglass frame colors, for display in augmented reality to the user. This selection process is improved and optimized based on captured facial characteristic data of the user as well as captured historical user selection preferences and other factors as described below. Additionally, mass personalization of eyeglass frame surface colors, patterns, textures, personalized lettering, and digital artistic media such as drawings and paintings for additively manufactured pre-designed fitted eyeglass frames is also provided. A subset of pre-designed and fitted eyeglass frames may be personalized using four processes: Process 1) pre-designed fitted frames that have already been configured with a single overall color may have that configured color changed to any other CMYK color; Process 2) pre-designed fitted frames that have already been configured with physical areas that can have changeable colors, changeable color-patterns, changeable textures and changeable texture-patterns; Process 3) pre-designed fitted frames that have already been configured with potential vectorized color areas, vectorized color-patterns areas, vectorized textures areas and vectorized texture-patterns areas; and, Process 4) pre-designed fitted frames that have already been selected can be also be completely customized as one-of-a-kind art with freehand designs by the retail customer themselves or an artist.

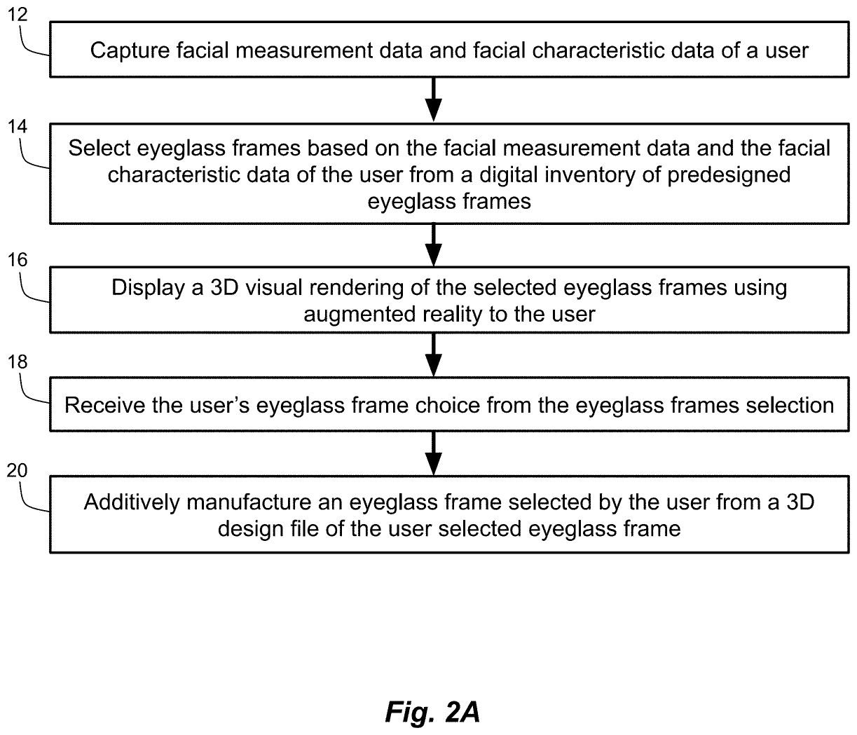

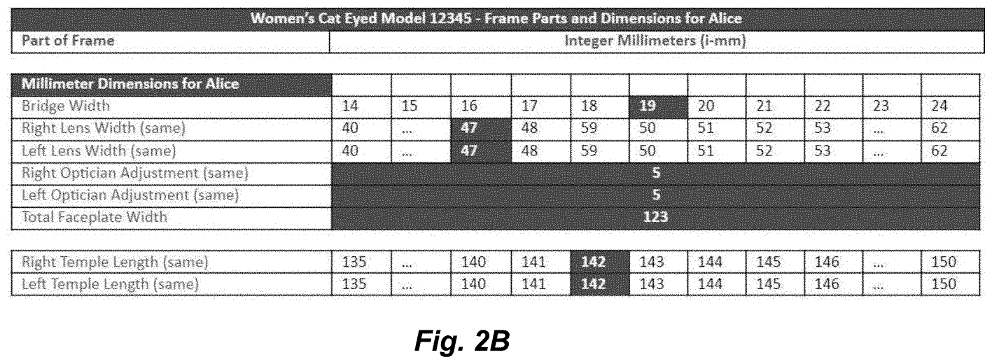

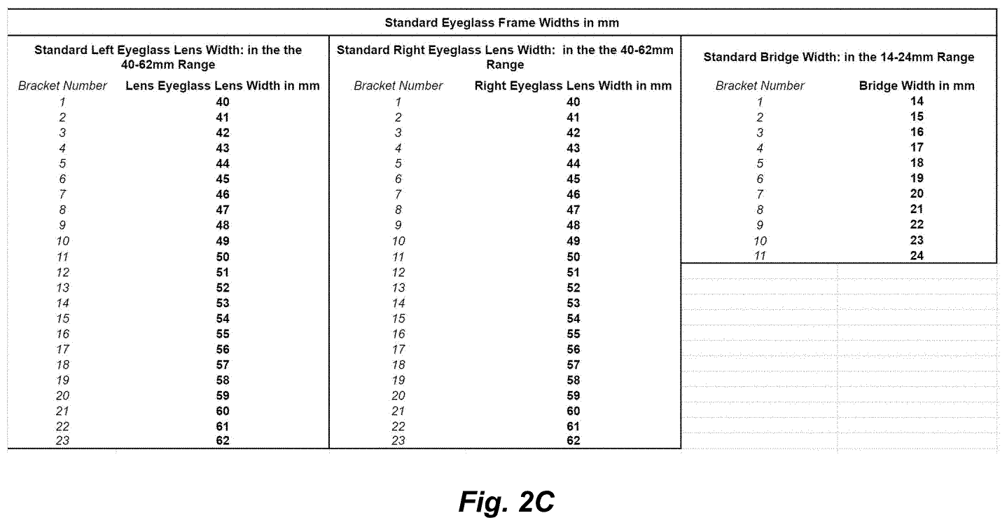

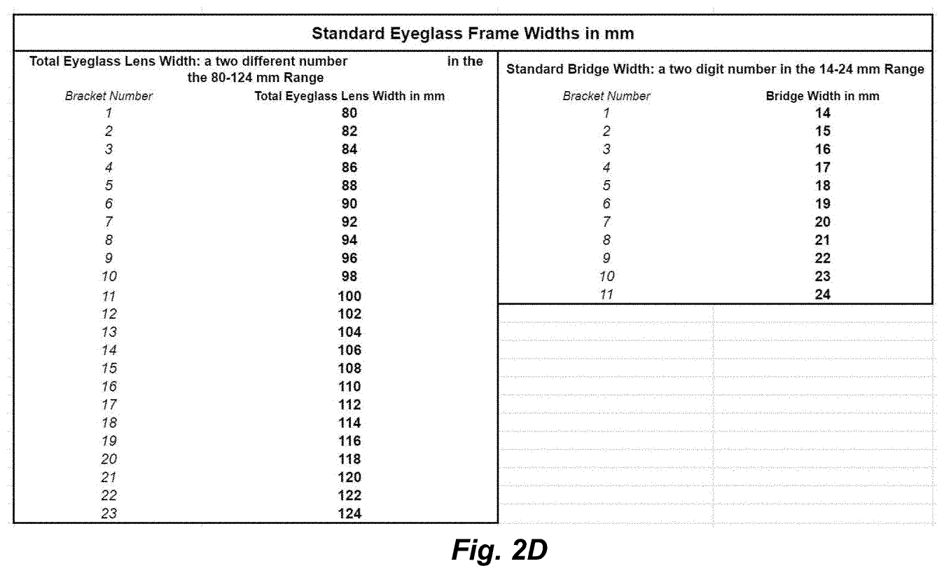

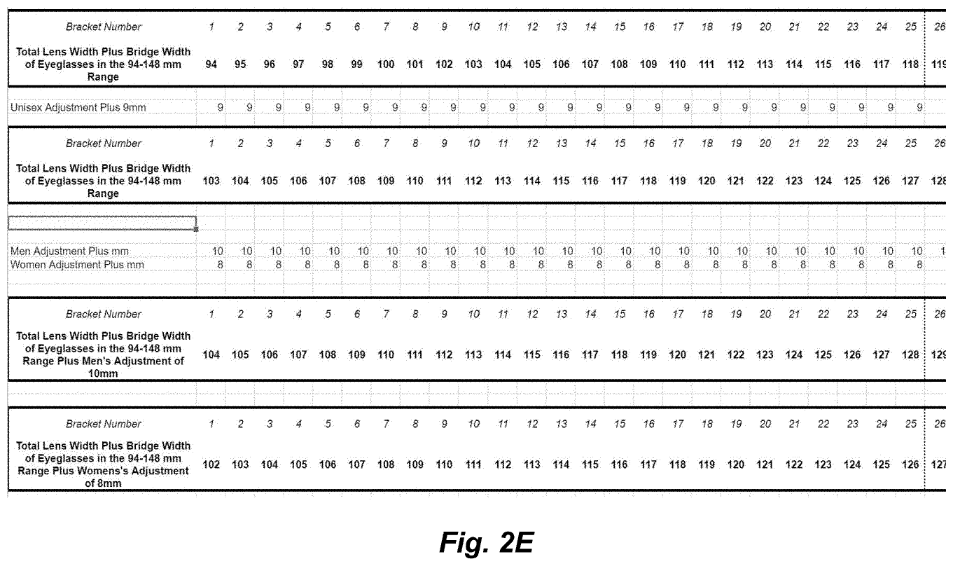

FIG. 2A is a flowchart illustrating the steps performed for additively manufacturing a user fitted eyeglass frame try-on using augmented reality and chosen by the user in accordance with a preferred embodiment of the disclosed solution. facial measurement data and facial characteristic data of a user is captured in step 12. This data is then used to determine a selection of fitted and design preferred eyeglass frames from a digital inventory of eyeglass frames for the user in step 14. A 3D visual rendering of the selected fitted eyeglass frames are then displayed to the user to try-on using augmented reality in step 16. Based on an eyeglass frame selection from the user received in step 18, the user selected eyeglass frame is additively manufactured from a 3D design file of the selected eyeglass frame in step 20.

FIG. 2B is a screenshot of an example of an information record table for a fitted eyeglass design determined for a user based on facial measurement data.

FIG. 2C through 2E are screenshots of global eyewear industry standard frame measurements tables in integer millimeter increments.

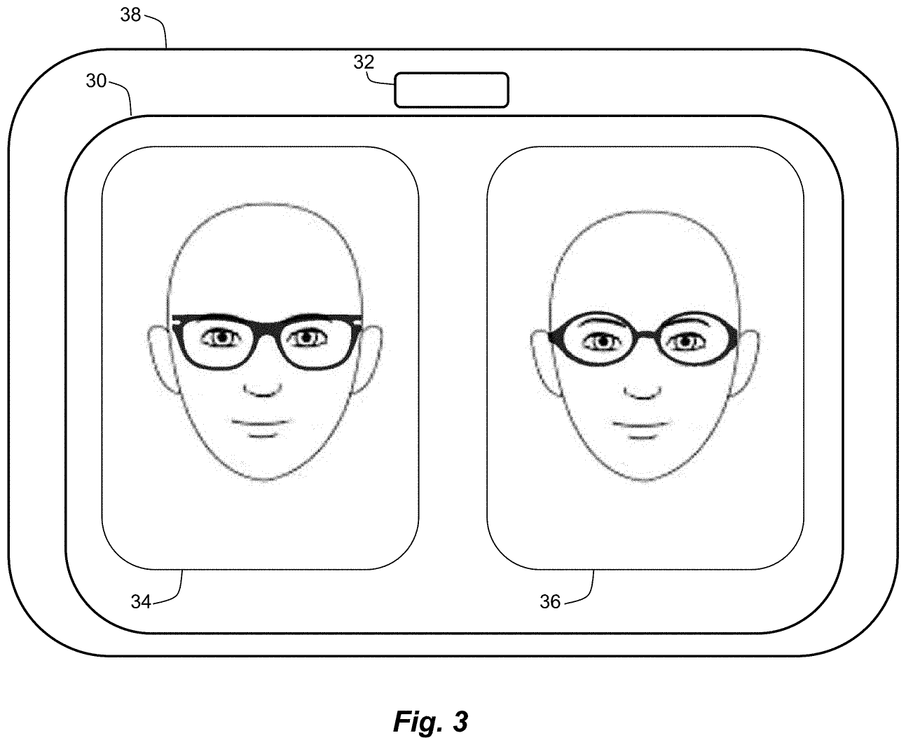

FIG. 3 is a schematic diagram illustrating an augmented reality side-by-side try-on interface, according to certain aspects of the disclosure. An interactive augmented reality based fitted eyeglass frame design selection is provided such that the user is displayed wearing two different fitted eyeglass frames in side-by-side augmented reality. In other words, the 3D visual renderings for the side-by-side comparisons of the selected eyeglass frames from the digital database (e.g., cloud server online access based digital database) are mapped onto the consumer's face as shown in the interface diagram of FIG. 3. Device screen display 30 on computing device 38 shows left display frame 34 side-by-side- with right display frame 36. Integrated camera and sensor 32 is positioned above device screen display 30.

The side-by-side display may be a 1×1 frame side-by-side display as shown in FIG. 3 or any frame combination greater than one (e.g., a 2×2 frame display, 2×3 frame display or 4×4 frame display). A 1×1 side-by-side display may be preferably over higher frame quantity displays such as a 2×2 side-by-side display or 4×4 side-by-side display for efficiency and pupil movement capture accuracy.

The present solution is advantageously described with reference to a number of tools and systems. The tools and systems also include, but are not limited to a camera, user interface display screen, and computing systems and applications for capturing and processing a user's facial data and providing on-screen augmented reality. Modern computing devices may combine elements of the above. For example, a combination of these known elements may include, and is described with reference to, a computer or laptop device capable of providing augmented reality, shown as computing device 38 in FIG. 3, for example such as an Apple iPad-Pro® with augmented reality application programming interface (API) framework ARKit (or alternatively ARCore) and integrated display screen side camera and 3D time-of-flight (ToF) depth sensor, shown as integrated camera and sensor 32 in FIG. 3, and embedded artificial intelligence processors such as ionic processors chip with 64-bit architecture and neural engines. This combination may advantageously be provided as an eyeglass frame selection station in an optical shop.

The selection of eyeglass frames based on the user's facial measurement data from the digital inventory of pre-designed 3D designs for additive manufacturing may be rank-ordered. For example, certain frame designs may be assigned a higher probability, and thus higher rank, of design acceptance by the user based on facial characteristics or general user characteristic inputs such as age or eyeglass budget. These rank-ordered eyeglass frames may be presented in rank-order.

An innovation and improvement of the disclosed solution is the display of a rank-ordered selection of fitted eyeglass frame designs in a 1×1 side-by-side seeded tournament bracket style selection. For example, if a selection of 8 fitted frames are chosen (the number of fitted frames selected is variable - for example 1, 2, 4, 8, 10, 16—and may be based on user input or selection efficiency and effectiveness considerations), these frames are ranked in order of predicted user acceptance 1 through 8. In the first round of tournament style selection process, fitted eyeglass frame ranked 1 is displayed side-by-side with fitted eyeglass frame ranked 8 for the user to choose between, eyeglass frame ranked 2 is displayed side-by-side with fitted eyeglass frame ranked 7 for the user to choose between and so on (3 vs 6, 4 vs 5). After this first round, the tournament bracket may continue with a chosen fitted eyeglass frames displayed side-by-side with another chosen fitted eyeglass frame as the original tournament bracket was structured, thus proceeding as NCAA Men's Basketball Championship commonly referred to as March Madness is played, until the user selection in the final side-by-side display designates the user's final fitted eyeglass frame selection. Or the chosen fitted eyeglass frames may be ranked such that the expected most preferred (i.e., highest ranked) chosen eyeglass frame design is presented against the expected least preferred (i.e., lowest ranked), this type of re-ranking after each round may be referred to as a reseeded tournament bracket. And while there are various iterations of these tournament selection styles, the innovation as described with reference to the disclosed solution is the side-by-side augmented reality based fitted eyeglass frame design selection.

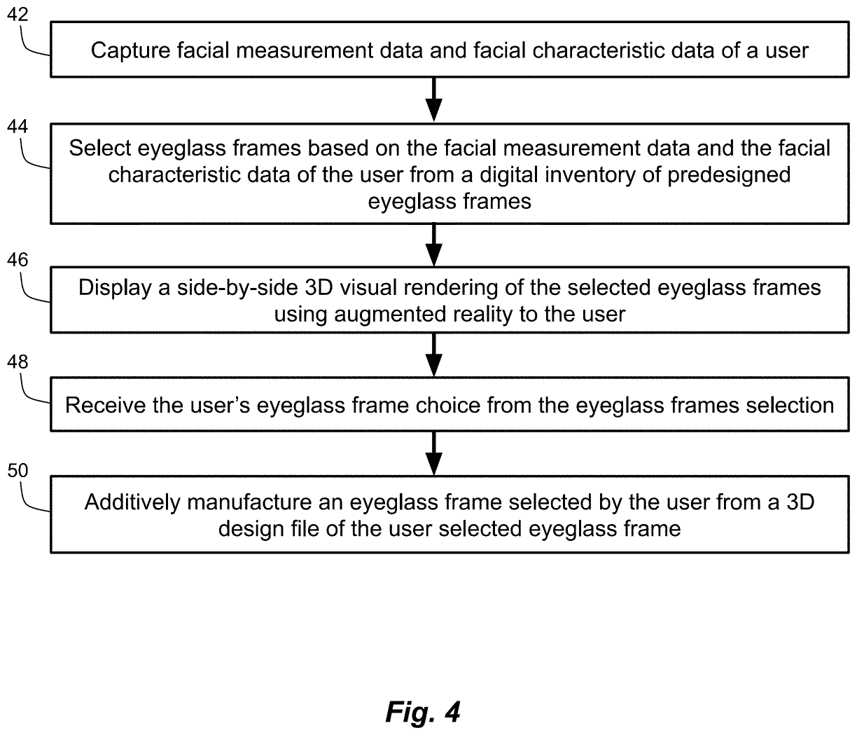

FIG. 4 is a flowchart illustrating the steps performed for additively manufacturing a user of fitted eyeglass frame try-on using augmented reality and chosen by the user in accordance with a preferred embodiment of the disclosed solution. facial measurement data and facial characteristic data of a user is captured in step 42. This data is then used to determine a selection fitted and design preferred eyeglass frames from a digital inventory of eyeglass frames for the user in step 44. A side-by-side 3D visual rendering of the selected fitted eyeglass frames are then displayed to the user to try-on using augmented reality in step 46. Based on an eyeglass frame selection from the user received in step 48, the user selected eyeglass frame is additively manufactured from a 3D design file of the selected eyeglass frame in step 50.

Measurement and capture of facial expressions is particularly challenging during the selection of eyeglass frames, and the selection of other 1 or head products such as hats as dental inserts, as the user will move their heads, and thus face, to view product fit and aesthetics to make their selection. Measurement and capture of facial expressions includes time-series responses to changes in the retail customer's individual and composite(s) of their left eye, right eye, mouth and jaw, eyebrows, cheeks and nose, and tongue as well as individual and composite(s) variables from pupil movement such pupil focus area, pupil dwell time, pupil revisit count, pupil dilation, and blink rate during viewing of an image.

Importantly, when combined with the innovations of emotional response cue capture based on facial expressions and facial expression changes as described below, the side-by-side augmented reality comparison of fitted eyeglass designs improves the measurement of facial expression and facial expression changes by providing target images. Measurement and capture of facial expressions is particularly challenging in the selection of eyeglass frames, and other facial or head products such as hats as dental inserts, as the user will move their heads, and thus face, to view product fit and aesthetics to make their selection. A side-by-side comparison provides displayed target images for improved and more accurately measured and captured facial expressions and facial expression changes as the user moves their eyes between display frame one having fitted eyeglass frame design one on the user's face and display frame two having fitted eyeglass frame design two on the user's face.

As the retail customer's facial data emotions and response are measured, different suggested eyeglass frame design lists and selected options displayed on screen may be presented.

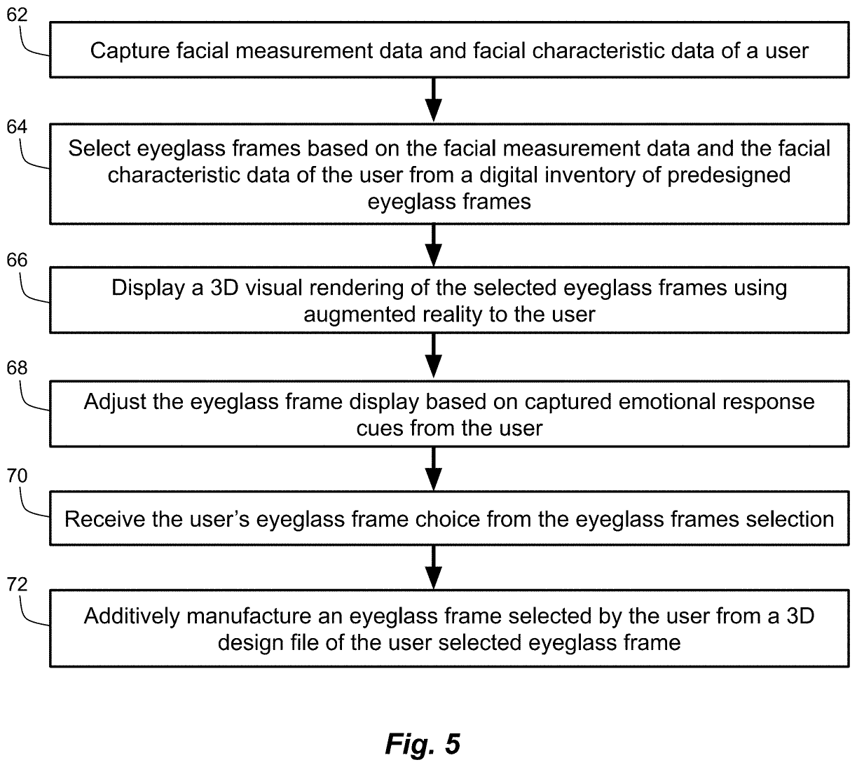

FIG. 5 is a flowchart illustrating the steps performed for additively manufacturing a user of fitted eyeglass frame try-on using augmented reality and chosen by the user in accordance with a preferred embodiment of the disclosed solution. facial measurement data and facial characteristic data of a user is captured in step 62. This data is then used to determine a selection fitted and design preferred eyeglass frames from a digital inventory of eyeglass frames for the user in step 64. A 3D visual rendering of the selected fitted eyeglass frames are then displayed to the user to try-on using augmented reality in step 66. In step 68, the eyeglass frame display is adjusted based on captured emotional response cues from the user. Based on an eyeglass frame selection from the user received in step 70, the user selected eyeglass frame is additively manufactured from a 3D design file of the selected eyeglass frame in step 72.

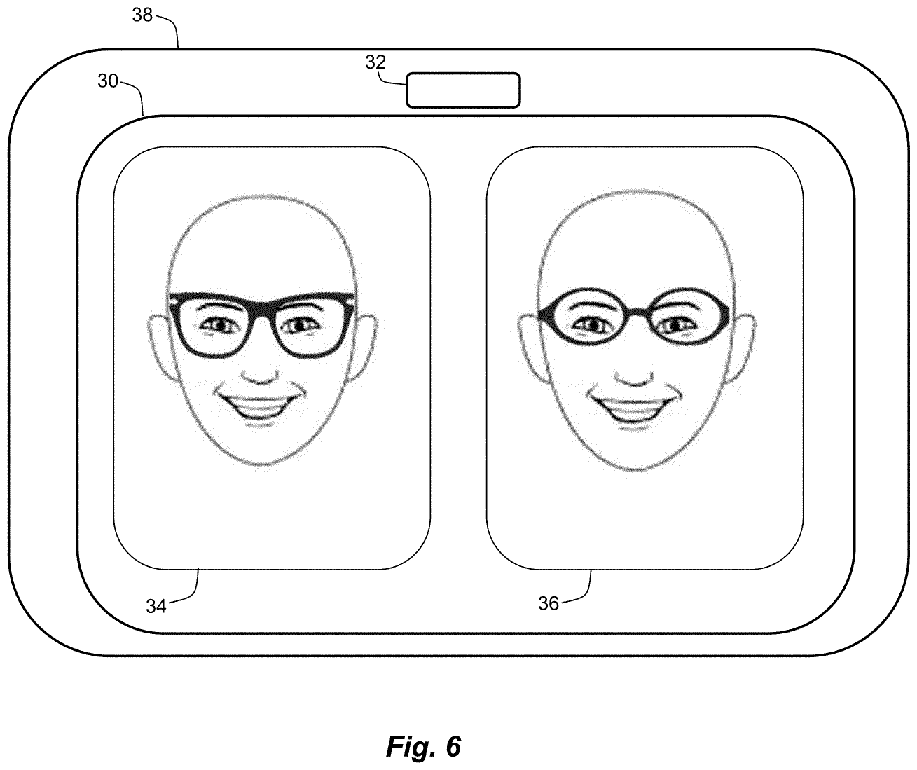

FIG. 6 is the schematic diagram illustrating an augmented reality side-by-side try-on interface of FIG. 3 and showing an emotive response cue.

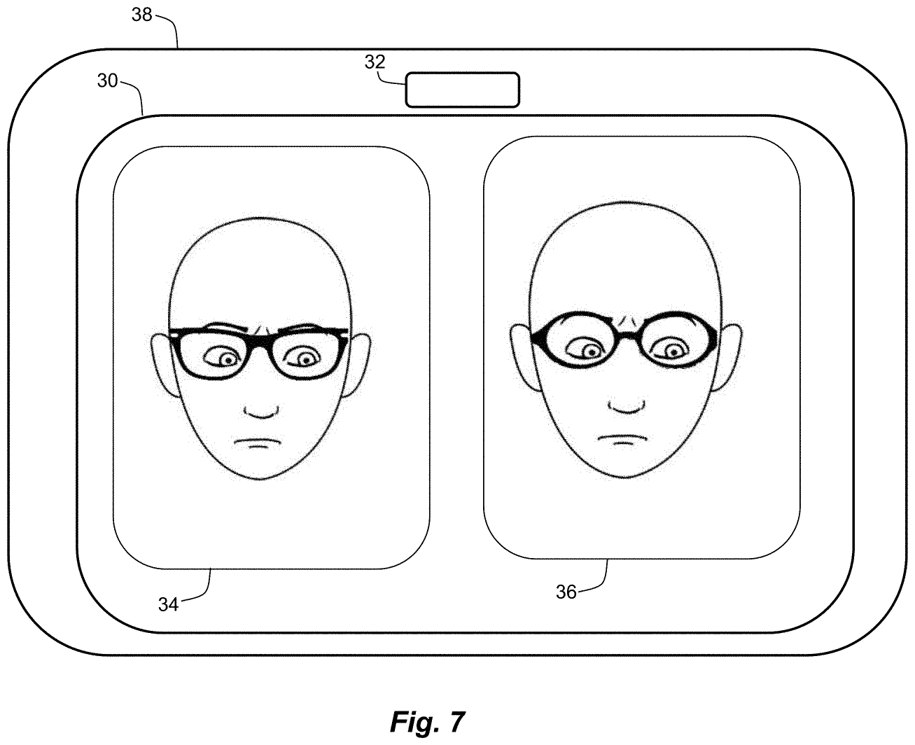

FIG. 7 is the schematic diagram illustrating an augmented reality side-by-side try-on interface of FIG. 3 and showing an emphasized emotive response cue as at right display frame 36.

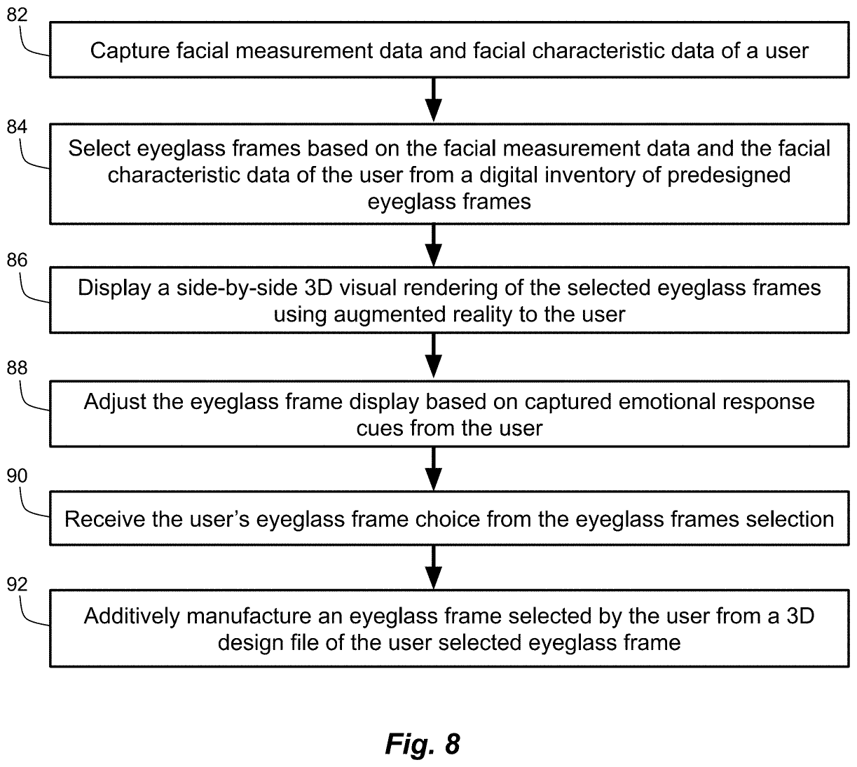

FIG. 8 is a flowchart illustrating the steps performed for additively manufacturing a user of fitted eyeglass frame tried-on using augmented reality and chosen by the user in accordance with a preferred embodiment of the disclosed solution. facial measurement data and facial characteristic data of a user is captured in step 82. This data is then used to determine a selection fitted and design preferred eyeglass frames from a digital inventory of eyeglass frames for the user in step 84. A side-by-side 3D visual rendering of the selected fitted eyeglass frames are then displayed to the user to try-on using augmented reality in step 86. In step 88, the eyeglass frame display is adjusted based on captured emotional response cues from the user in step 86. Based on an eyeglass frame selection from the user received in step 90, the user selected eyeglass frame is additively manufactured from a 3D design file of the selected eyeglass frame in step 92.

Mass personalization allowing the user to add specific preferences to pre-designed eyeglass frames such as eyeglass frame surface colors, patterns, textures, personalized lettering, and digital artistic media such as drawings and paintings for additively manufactured pre-designed fitted eyeglass frames is provided. If a pre-designed frame is selected by a user for personalization, a 3D visual rendering of pre-designed frame specifications from the digital inventory is provided. In other words, retail customers may select surface colors, color patterns, textures, and texture-patterns that will fit on the surface of each piece of the frame as pre-defined scalable vectors including special personalized lettering and graphics to be printed on the frames. Thus the user may personalize the selected eyeglass frames in selecting surface colors, textures, color patterns, and texture-patterns that will fit on the surface of each piece of the frame despite size or shape of the surface. Digital media of surface designs, patterns and textures may be uploaded as color patterns as well.

3D color printers may print eyeglass frames in multiple colors, patterns and textures without requiring a separate dying process to manufacture eyeglass frames with pre-defined color patterns and surface textures. Printing capabilities of 3D color printers include full CMYK color, layer thicknesses in the range of 0.08 mm, printhead resolutions of up 1200 dpi. Relating to CMYK color printing, these CMYK colors (cyan, magenta, yellow, and black) are the inks used on the press in “4-color process printing” which commonly referred to as “full color printing” or “four color printing”. The present solution provides for CMYK surface colors and color-patterns—displayed symmetrically or asymmetrically—for printing on eyeglass frame faceplates and temple pieces. Thus any CMYK color or color pattern that will physically fit or may be scaled to fit on the pre-designed eyeglass frames in the digital inventory may be digitally applied and manufactured.

Relating to textures, texture mapping properties manage texture map projections for selected surfaces, polysurfaces, and meshes. Mapping is a process of defining how to represent a 2D image on a 3D model. Mapping transforms a 2D source image into an image buffer called a texture. A texture can be applied to the surface of a 3D model to add colors, texture, or other surface detail like glossiness, reflectivity, or transparency. The challenge of representing the texture in 3D rendering is overcome with a uv-mapping solution. U and V are the coordinates of the texture corresponding to X and Y. Consider U as one direction on a piece of graph paper (side to side) and V as the other direction (up and down). When an image is applied in a material and then that material is applied to a model, uv-texture mapping is used. And although any texture or pattern may be available, categories of the textures considered most appropriate for eyeglass frames are wood, fabric/leather, metal, rock, and sandstone.

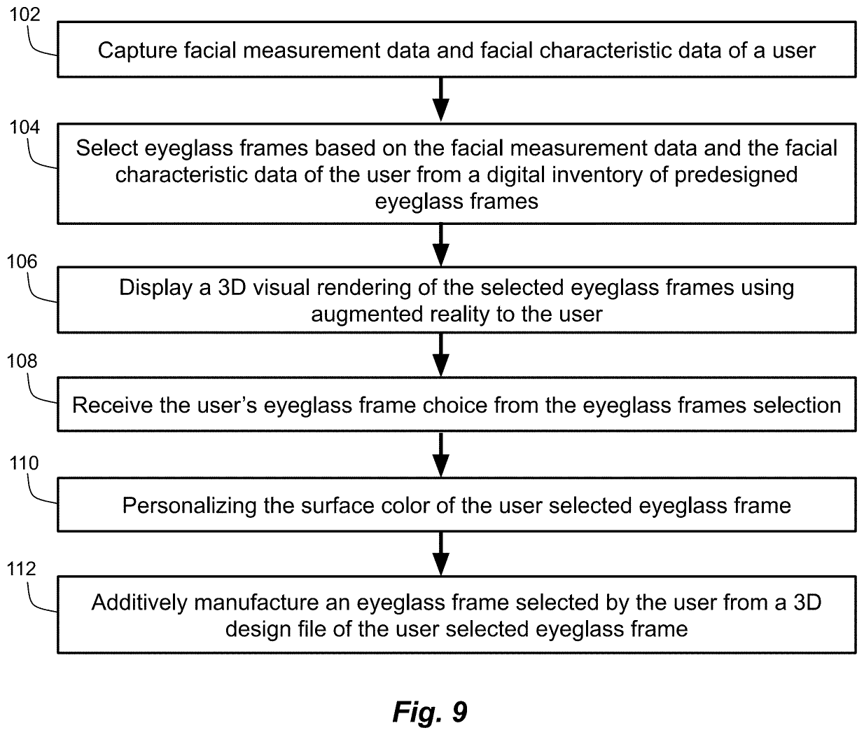

FIG. 9 is a flowchart illustrating the steps performed for additively manufacturing a user of fitted eyeglass frame try-on using augmented reality and chosen by the user in accordance with a preferred embodiment of the disclosed solution. facial measurement data and facial characteristic data of a user is captured in step 102. This data is then used to determine a selection fitted and design preferred eyeglass frames from a digital inventory of eyeglass frames for the user in step 104. A 3D visual rendering of the selected fitted eyeglass frames are then displayed to the user to try-on using augmented reality in step 106. Based on an eyeglass frame selection from the user received in step 108 which is surface color personalized in step 110, the user selected eyeglass frame is additively manufactured from a 3D design file of the selected eyeglass frame in step 112.

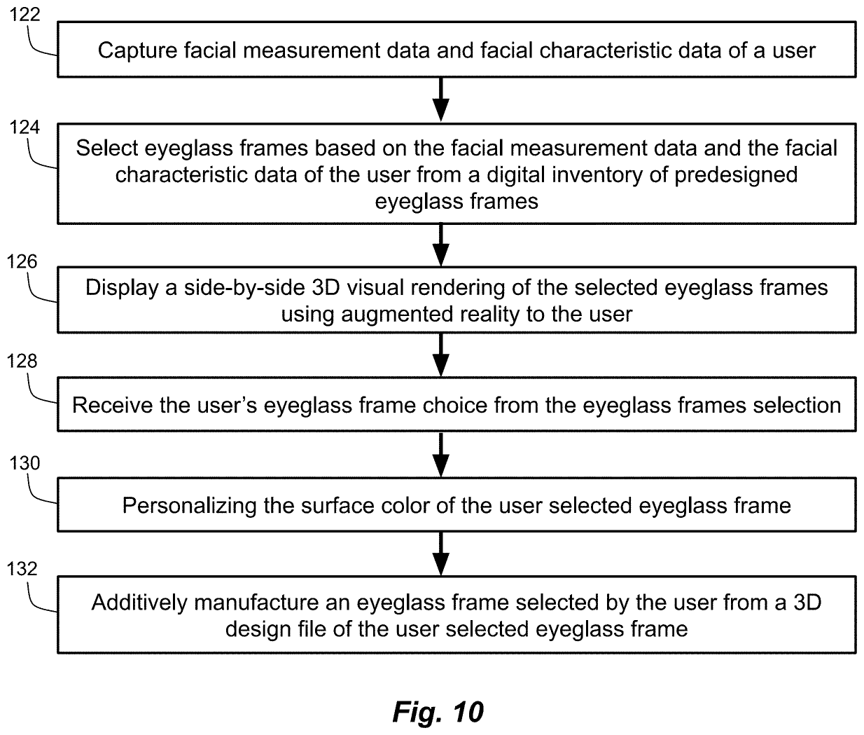

FIG. 10 is a flowchart illustrating the steps performed for additively manufacturing a user of fitted eyeglass frame try-on using augmented reality and chosen by the user in accordance with a preferred embodiment of the disclosed solution. facial measurement data and facial characteristic data of a user is captured in step 122. This data is then used to determine a selection fitted and design preferred eyeglass frames from a digital inventory of eyeglass frames for the user in step 124. A side-by-side 3D visual rendering of the selected fitted eyeglass frames are then displayed to the user to try-on using augmented reality in step 126. In step 128, the eyeglass frame display is adjusted based on captured emotional response cues from the user in step 126. Based on an eyeglass frame selection from the user received in step 128 which is surface color personalized in step 130, the user selected eyeglass frame is additively manufactured from a 3D design file of the selected eyeglass frame in step 132.

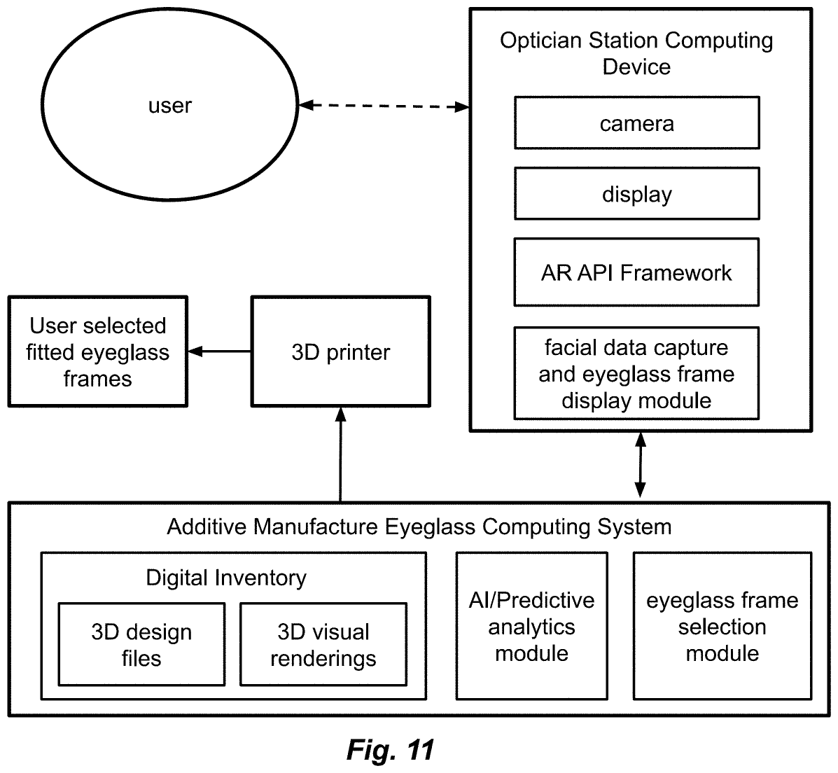

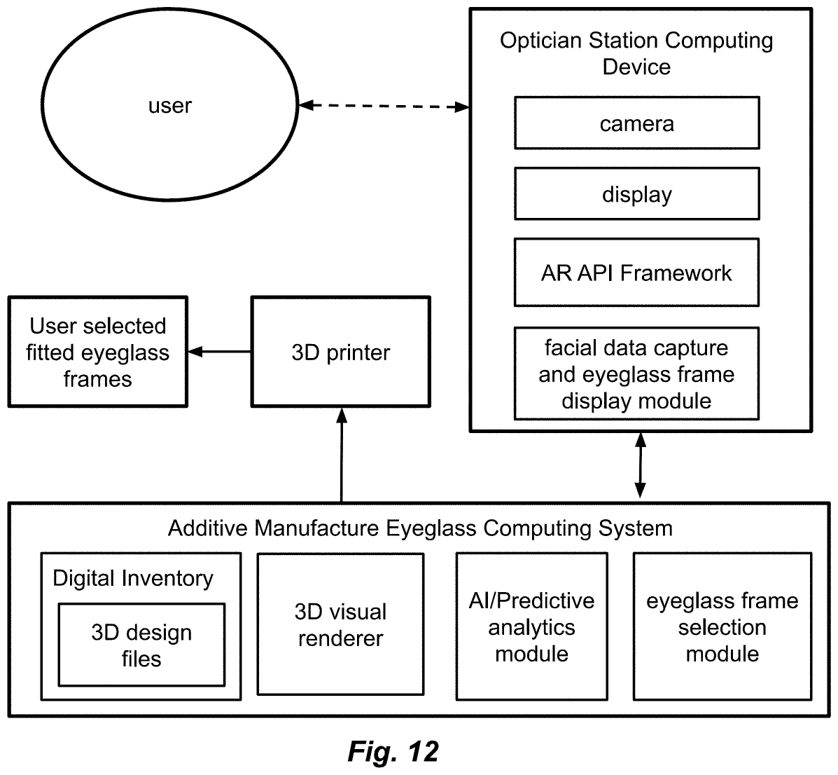

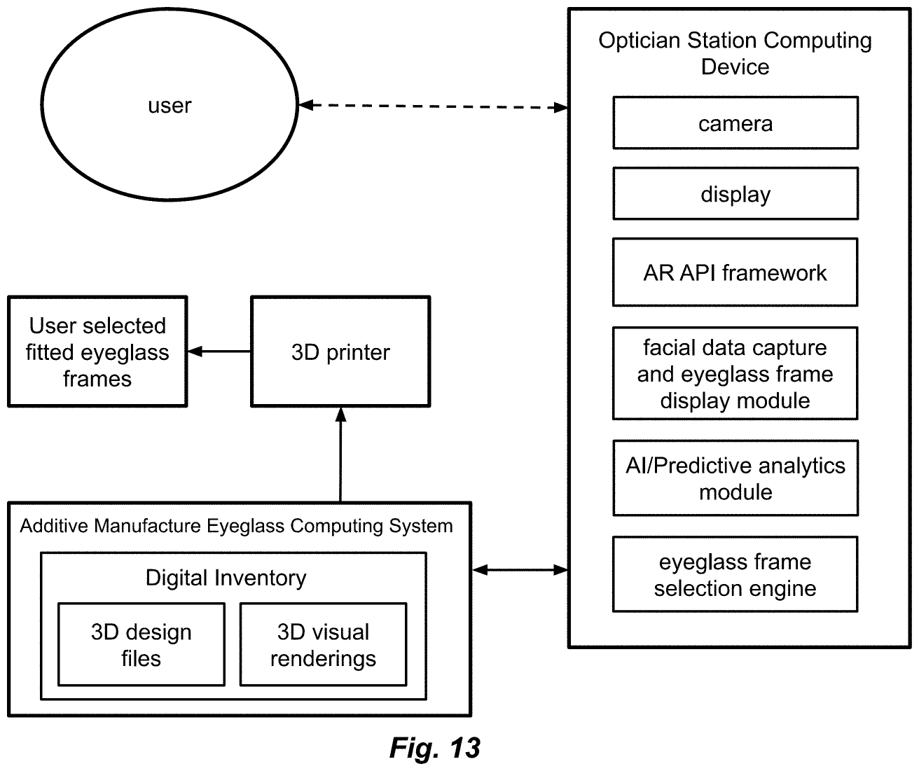

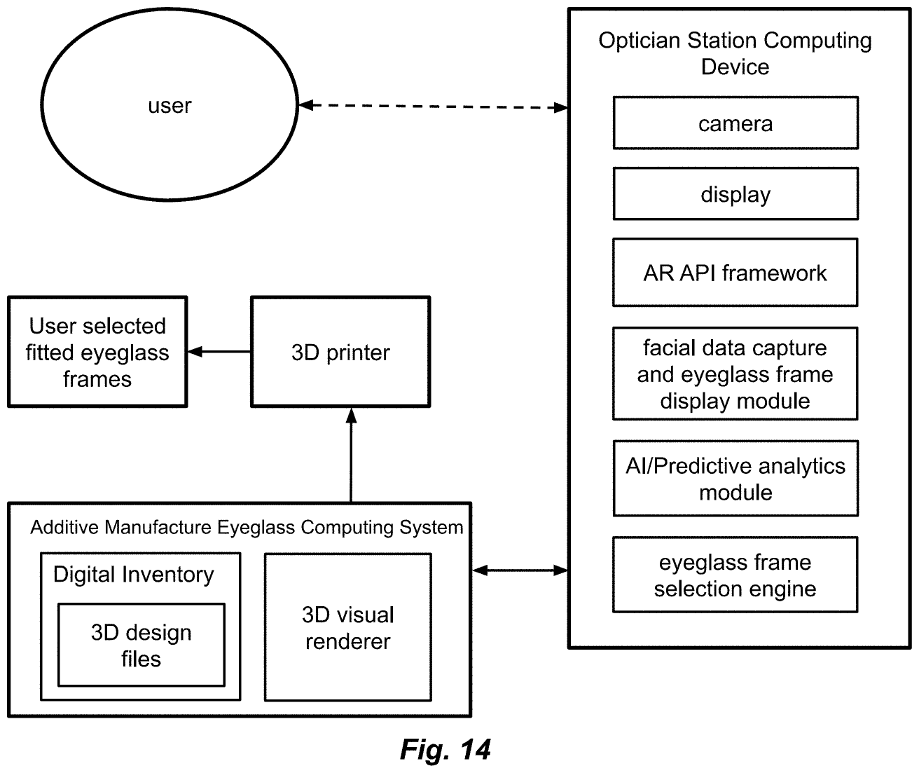

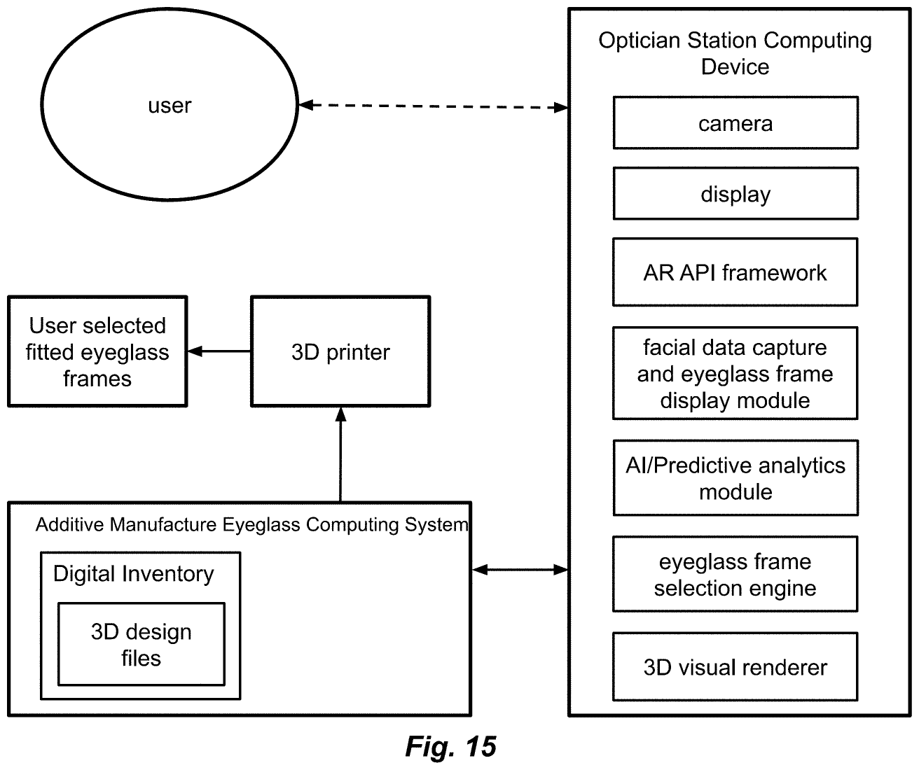

FIGS. 11 through 15 are block diagrams of exemplary systems for additively manufacturing a user fitted eyeglass frame try-on using augmented reality and chosen by the user in accordance with preferred embodiments of the disclosed solution. The 3D printer for manufacturing eyeglass frames, may be for example a printer such as a selective laser sintering (SLS) 3D printer capable of printing Nylon PA 12 products (e.g., EOS Formiga P110 printer) or cellulose acetate 3d printers.

What is claimed is:

1. A computer-implemented method for real time augmented reality selection of user fitted eyeglass frames for additive manufacture, using a computer system, the method comprising:
capturing facial measurement data of a user;
selecting fitted eyeglass frames based on said facial measurement data from a digital inventory of 3D eyeglass designs for additive manufacturing;
displaying 3D visual renderings of said selection of fitted eyeglass designs on a user's face using augmented reality; and
determining a 3D eyeglass design from said digital inventory for additive manufacturing based on user selection of a displayed 3D visual renderings of an eyeglass design.

2. The computer-implemented method as recited in claim 1, wherein said 3D eyeglass designs for additive manufacturing are based on universal standards in integer millimeters.

3. The computer-implemented method as recited in claim 1, wherein said displaying 3D visual renderings of said selection of fitted eyeglass designs on a user's face using augmented reality are displayed in a seeded tournament bracket style selection.

4. The computer-implemented method as recited in claim 3, wherein the frames are re-ranked after each round.

5. A computer-implemented method for real time augmented reality selection of user fitted eyeglass frames for additive manufacture, using a computer system, the method comprising:
capturing facial measurement data of a user;
selecting fitted eyeglass frames based on said facial measurement data from a digital inventory of 3D eyeglass designs for additive manufacturing;
displaying side-by-side 3D visual renderings of said selection of fitted eyeglass designs on a user's face using augmented reality; and
determining a 3D eyeglass design from said digital inventory for additive manufacturing based on user selection of a displayed 3D visual renderings of an eyeglass design.

6. The computer-implemented method as recited in claim 5, wherein said 3D eyeglass designs for additive manufacturing are based on universal standards in integer millimeters.

7. The computer-implemented method as recited in claim 5, wherein said displaying 3D visual renderings of said selection of fitted eyeglass designs on a user's face using augmented reality are displayed in a seeded tournament bracket style selection.

8. The computer-implemented method as recited in claim 7, wherein the frames are re-ranked after each round.

9. A computer-implemented method for real time augmented reality selection of user fitted eyeglass frames for additive manufacture, using a computer system, the method comprising:
capturing facial measurement data of a user;
selecting fitted eyeglass frames based on said facial measurement data from a digital inventory of 3D eyeglass designs for additive manufacturing;
displaying 3D visual renderings of said selection of fitted eyeglass designs on a user's face using augmented reality;
capturing emotional response cues to eyeglass frame designs of said eyeglass frame selection;
displaying 3D visual renderings of said selection of fitted eyeglass designs on a user's face using augmented reality based on said captured emotional response cues; and
determining a 3D eyeglass design from said digital inventory for additive manufacturing based on user selection of a displayed 3D visual renderings of an eyeglass design.

10. The computer-implemented method as recited in claim 9, wherein said 3D eyeglass designs for additive manufacturing are based on universal standards in integer millimeters.

11. The computer-implemented method as recited in claim 9, wherein said displaying 3D visual renderings of said selection of fitted eyeglass designs on a user's face using augmented reality are displayed in a seeded tournament bracket style selection.

12. The computer-implemented method as recited in claim 12, wherein the frames are re-ranked after each round.

13. A computer-implemented method for real time augmented reality selection of user fitted eyeglass frames for additive manufacture, using a computer system, the method comprising:
capturing facial measurement data of a user;
selecting fitted eyeglass frames based on said facial measurement data from a digital inventory of 3D eyeglass designs for additive manufacturing;
displaying side-by-side 3D visual renderings of said selection of fitted eyeglass designs on a user's face using augmented reality;
capturing emotional response cues to eyeglass frame designs of said eyeglass frame selection;
displaying side-by-side 3D visual renderings of said selection of fitted eyeglass designs on a user's face using augmented reality based on said captured emotional response cues; and
determining a 3D eyeglass design from said digital inventory for additive manufacturing based on user selection of a displayed 3D visual renderings of an eyeglass design.

14. The computer-implemented method as recited in claim 13, wherein said 3D eyeglass designs for additive manufacturing are based on universal standards in integer millimeters.

15. The computer-implemented method as recited in claim 13, wherein said displaying 3D visual renderings of said selection of fitted eyeglass designs on a user's face using augmented reality are displayed in a seeded tournament bracket style selection.

16. The computer-implemented method as recited in claim 15, wherein the frames are re-ranked after each round.

17. A computer-implemented method for real time augmented reality selection of user fitted eyeglass frames for additive manufacture, using a computer system, the method comprising:
capturing facial measurement data of a user;
selecting fitted eyeglass frames based on said facial measurement data from a digital inventory of 3D eyeglass designs for additive manufacturing;
displaying 3D visual renderings of said selection of fitted eyeglass designs on a user's face using augmented reality;
personalizing the surface color of a user selected eyeglass frame; and
determining a 3D eyeglass design from said digital inventory for additive manufacturing based on user selection of a displayed 3D visual renderings of an eyeglass design.

18. The computer-implemented method as recited in claim 17, wherein said 3D eyeglass designs for additive manufacturing are based on universal standards in integer millimeters.

19. The computer-implemented method as recited in claim 17, wherein said displaying 3D visual renderings of said selection of fitted eyeglass designs on a user's face using augmented reality are displayed in a seeded tournament bracket style selection.

20. The computer-implemented method as recited in claim 19, wherein the frames are re-ranked after each round.

21. A computer-implemented method for real time augmented reality selection of user fitted eyeglass frames for additive manufacture, using a computer system, the method comprising:
capturing facial measurement data of a user;
selecting fitted eyeglass frames based on said facial measurement data from a digital inventory of 3D eyeglass designs for additive manufacturing;
displaying side-by-side 3D visual renderings of said selection of fitted eyeglass designs on a user's face using augmented reality;
capturing emotional response cues to eyeglass frame designs of said eyeglass frame selection;
displaying side-by-side 3D visual renderings of said selection of fitted eyeglass designs on a user's face using augmented reality based on said captured emotional response cues;
personalizing the surface color of a user selected eyeglass frame; and
determining a 3D eyeglass design from said digital inventory for additive manufacturing based on user selection of a displayed 3D visual renderings of an eyeglass design.

22. The computer-implemented method as recited in claim 21, wherein said 3D eyeglass designs for additive manufacturing are based on universal standards in integer millimeters.

23. The computer-implemented method as recited in claim 21, wherein said displaying 3D visual renderings of said selection of fitted eyeglass designs on a user's face using augmented reality are displayed in a seeded tournament bracket style selection.

24. The computer-implemented method as recited in claim 23, wherein the frames are re-ranked after each round.
